(19) United States
(12) Patent Application Publication
(10) Pub. No.: US 2003/0221748 A1
(43) Pub. Date: Dec. 4, 2003

(54) Solder paste flux system

(75) Inventors: Bensol Arzadon, Old Bridge, NJ (US); Andrew David Price, Carshalton (GB); Leela Josephine Sequeira, Croydon (GB); Leszek Hozer, Plainsboro, NJ (US)

Correspondence Address: SENNIGER POWERS LEAVITT AND ROEDEL, ONE METROPOLITAN SQUARE, 16TH FLOOR, ST LOUIS, MO, 63102, US

(73) Assignee: Fry's Metals, Inc.

(21) Appl. No.: 10/158,251

(22) Filed: May 30, 2002

(51) Int. Cl. B23K 35/34

(52) U.S. Cl. 148/23

(57) ABSTRACT

The present invention is directed to a solder flux and solder paste that comprises methylsuccinic acid as an activating component and an imidazole compound as an accelerating component. The imidizole compound is selected from the following: 2-methyl-4-ethylimidazole, 2-methylimidazole and 2-ethylimidazole and mixtures thereof. The present invention is also directed to a method for preparing the above-described solder flux and method for soldering using the solder flux paste. It is also directed to an electronic component assembly joined using the solder flux paste.

### BACKGROUND OF THE INVENTION

1. Field of the Invention

This invention relates to a flux system for activation and method of fluxing of integrated circuit (IC) devices. More particularly, the invention is directed to including methylsuccinic acid as an activator and an imidazole compound as an accelerator for fluxing during a soldering operation.

2. Background Information

Solder paste is a mixture of a flux composition and a powdered solder metal alloy that is widely used in the electronics industry. At room temperature the solder paste is compliant enough so that it can be made to conform to virtually any shape. At the same time, it is “tacky” enough that it tends to adhere to any surface it is placed into contact with. These qualities make solder paste useful for both surface mount soldering and for forming solder bumps, on electronic components such as ball grid array packages or on the board to attach BGA's.

In general, the surface mount soldering process involves placing the electrical contact of an electronic component or substrate, a small amount of solder paste, and a solder-wettable pad on a printed circuit board in close proximity. They are then heated until the solder reflows, forming an electrical connection between the solder-wettable pad and the electrical contact of the electronic component. Once the solder has reflowed, it forms both an electrical and a mechanical connection between the electronic component and the printed circuit board. This process has numerous advantages over other methods of interconnection. First, a large number of components can be interconnected simultaneously. Second, the process is highly repeatable and relatively low cost and is easily adapted for mass production.

The surface mount soldering process typically begins by stenciling or screen printing a solder paste onto the solder-wettable pads of a printed circuit board. Once the solder paste is on the solder-wettable pads, the electronic components to be soldered are aligned and set into place on the printed circuit board with the electrical contacts of the electronic components in contact with the solder paste. The solder paste holds the electronic components in place during the reflow process.

During the reflow process the solder paste is heated to a temperature which: 1) allows the flux to remove oxides from all surfaces involved in the soldering operation (e.g., substrate, solder pads, solder bumps and solder alloy powder), and 2) sufficiently melts the solder powder so that it coalesces into a single liquid body. The reflowed solder contacts the solder pads and/or substrate, and, once cooled, solidifies to form a complete, electrically conductive solder joint.

To form a completely fused and strong solder joint, the solder must adequately “wet” the solder pad and/or substrate. Wetting depends in large part on the metallurgical reaction between solder and soldering surface, and on the efficacy of the solder paste flux. Wetting is more efficient whenever the molten solder is in contact with a clean, oxide-free surface. Thus, the temperature at which the solder powder melts and the duration that solder paste is held above the temperature at which the flux reaction occurs are important factors for ensuring good wetting and a strong solder joint. However, if the flux does not adequately remove oxides from the metals being joined during the reflow operation the oxides retard or prohibit the coalescence of the solder and “solder balling” and incomplete fusion occurs. The term “solder balling” refers to the undesirable tendency of a solder paste, when heated during reflow, to form small spheres of solder instead of forming a single solder fillet. Additionally, the joint will be incompletely fused, weak and subject to “voiding.” Without being held to a particular theory, it is presently believed that the mechanism behind voiding formation is the entrapment of excess solder flux or its vapors within the solder alloy. Either the composition of the flux or the reflow profile prevent the flux and/or its vapors from escaping during the reflow cycle which upon cooling cause internal void in the solder joint.

In summation, the flux composition provides several characteristics necessary for such soldering operations. For example, the solder paste flux must have an appropriate viscosity, rheology, tack and slump to suspend the metal solder powder, allow printing and secure electronic components while uncured (i.e., prior to and during reflow). The flux must also remove oxides from the metal surfaces at the appropriate temperatures and must be able to protect against oxidation for a sufficient duration during and after the reflow operation. Additionally, the flux and/or its residues preferably do not corrode the solder metal prior to, during or following the soldering operation.

Known solder paste flux compositions (e.g., those suitable for Sn—Pb solders), although effective under standard reflow conditions (e.g., about 200° C. to about 220° C. for about 30 seconds to about 90 seconds), are inadequate when subjected to accelerated or prolonged oxidation during reflow. These harsh conditions are usually the result of reflowing the solder paste in an oxidizing atmosphere with high peak temperature (e.g., above about 230° C.), and with a slow temperature ramp (about 1° C./sec to about 2° C./sec), prolonged soak (e.g., more than about 60 seconds above about 160° C.). Although these harsh reflow conditions may occur when soldering with any solder composition, they are typically necessary when reflowing lead-free soldering alloys or solder alloys with high Pb/Sn ratios (e.g., Pb>37wt %) both of which exhibit liquidus temperatures that are significantly higher than that of the ubiquitous Sn₆₃Pb₃₇ alloy (about 183° C.). Another situation which requires enhanced flux protection is the reflow of small solder deposits (e.g., deposits that are less than about 300 μm wide) because the protective layer of liquid flux is thin and susceptible to penetration by oxygen. As such, a need continues to exist for a solder paste flux that has improved oxide removal activity (i.e., fluxing activity) and increased resistance to oxidation at the higher temperatures for longer durations.

### SUMMARY OF THE INVENTION

Among the objects of the invention are the provision of a solder paste flux having an appropriate viscosity, rheology, tack and slump to suspend the metal solder powder, allow printing and secure electronic components while uncured (i.e., prior to and during reflow); the provision of a solder paste flux that removes oxides from the metal surfaces at elevated temperatures necessary for Pb-free solder alloys; the provision of a solder paste flux that protects against oxidation for prolonged soldering durations necessary for Pb-free soldering; the provision of a solder flux paste that does not corrode the solder metal prior to, during or following the soldering operation; and the provision of a solder flux paste that protects small solder deposits (e.g., deposits that are less than about 300 μm wide) during a reflow operation.

Briefly, therefore, the present invention is directed to a solder flux composition comprising a base component, a solvent component, an activating component comprising methylsuccinic acid, and an accelerating component comprising an imidazole compound selected from the group consisting of 2-methyl-4-ethylimidazole, 2-methylimidazole and 2-ethylimidazole and mixtures thereof.

The present invention is also directed to a solder flux composition comprising, in weight percent, a hydrogenated resin from about 13.0 to about 23.0%, a hydrogenated gum wood rosin from about 13.0 to about 23.0%, a glycol ether from about 14.0 to about 30.0%, a hydroxyl terminated polybutadiene from about 6.0 to about 12.0%, a petroleum distillate from about 3.0 to about 15.0%, methylsuccinic acid from about 4.0 to about 17.0%, 2-ethylimidazole from about 3.0 to about 10.5%, optionally, a thixatrope up to about 13%, optionally, phosphine derivative up to about 2.0% and optionally, triazole derivative up to about 2.5%.

Additionally, the present invention is directed to a solder paste comprising a metal solder powder dispersed in a solder flux composition. The solder flux composition comprises a base component, a solvent component, an activating component comprising methylsuccinic acid, an accelerating component comprising an imidazole compound selected from the group consisting of 2-methyl-4-ethylimidazole, 2-methylimidazole and 2-ethylimidazole and mixtures thereof. optionally, the solder flux composition comprises a rheological component and a corrosion inhibitor component.

Further, the present invention is directed to a process for joining two solderable surfaces. The process comprises applying to at least one of the solderable surfaces a deposit of a solder paste, the solder paste comprising a metal solder powder and a solder flux composition, the solder flux composition comprising a base component, a solvent component, an activating component comprising methylsuccinic acid, and an accelerating component comprising an imidazole compound selected from the group consisting of 2-methyl-4-ethylimidazole, 2-methylimidazole and 2-ethylimidazole and mixtures thereof. Heat is applied to at least one solderable surface to reflow the solder paste thereby wetting both solderable surfaces with molten solder and the molten solder is cooled to solidify the solder thereby joining the two solderable surfaces.

The present invention is also directed to an electronic component assembly comprising an electronic component having a plurality solder-wettable pads, a substrate having electrical contacts corresponding to the solder-wettable pads of the electronic component, and a solder paste between the solder-wettable pads and the electrical contacts. The solder paste comprises a metal solder powder and a solder flux composition which comprises a base component, a solvent component, an activating component comprising methylsuccinic acid, and an accelerating component comprising an imidazole compound selected from the group consisting of 2-methyl-4-ethylimidazole, 2-methylimidazole and 2-ethylimidazole and mixtures thereof. The solder flux composition optionally comprises a rheological component, and a corrosion inhibitor component.

The present invention is still further directed to a method of preparing a solder flux composition comprising mixing an activating component comprising methylsuccinic acid with an accelerating component comprising 2-ethylimidazole.

The foregoing and other features and advantages of the present invention will become more apparent from the following description.

### DETAILED DESCRIPTION OF THE INVENTION

The present invention is directed to a solder flux that comprises methylsuccinic acid (also referred to pyrotartaric acid). The IUPAC nomenclature for methylsuccinic acid is 2-methyl-1,4-butanedioic acid. The chemical formula for methylsuccinic acid is HO₂CCH(CH₃)CH₂CO₂H. Surprisingly, the inclusion of methylsuccinic acid in a solder flux provides several benefits such as increased fluxing activity, increased oxidation protection, and improved degradation resistance with increasing temperature and duration.

The methylsuccinic acid may be included in the flux of any applicable type of solder operation. It is, however, particularly useful as part of the flux composition mixed with a powdered solder alloy to create a solder paste. Hence, the following discussion is directed to the inclusion of methylsuccinic acid in solder paste applications. The viscous flux composition of the present invention comprises a base component, a solvent component, and an activator component. Optionally, the flux composition may comprise an accelerator component, a rheological component, and/or a corrosion inhibitor component.

Base Component

The soldering fluxes of the present invention are typically classified as an oil-soluble type in which the base component is a thermoplastic or thermosetting resin. Preferably, the base component comprises a thermoplastic resin such as rosins, modified rosins, rosin-modified resins and synthetic resins. Exemplary rosins, modified rosins and rosin-modified resins include wood rosin, gum rosin, tall oil rosin, disproportionated rosin, hydrogenated rosin, polymerized rosin, hydrogenated resin, hydrogenated gum wood rosin and Poly BD R45HTLO resin (Elf Atochem, Philadelphia, Pa.). Exemplary synthetic resins include carboxyl-containing resins such as polyester resins, acrylic resins and styrenemaleic resins, epoxy resins, resol or novolac phenolic resins and KE 604 (Arakawa Chemicals, Japan) and Foral AX (Hercules Inc., Wilmington, Del.). The base component may comprise one or more of the foregoing thermoplastic resins. Preferably the base component comprises about 5 to about 95 wt % of the flux and more preferably from about 20 to about 50 wt %. The base component prevents solder oxidation at elevated temperatures, provides a protective barrier against oxygen and also activates soldering surfaces by removing oxygen from the surfaces and the solder.

Solvent Component

The flux of the present invention comprises a solvent component. The purpose of the solvent is to dissolve the base component and other flux components, disperse non-soluble flux components, and coat the solder metal alloy powder. If the solvent is volatile, it will also promote fast setting after the flux is applied to the substrate. During the reflow operation the solvent evaporates leaving behind the other reacted and/or unreacted flux components.

Exemplary solvents include ketones such as acetone and methyl ethyl ketone; alcohols such as methanol, ethanol, isopropyl alcohol, methylcellosolve, ethylcellosolve, 1-methoxy-2-propanol, carbitol and butylcarbitol; esters of such alcohols; aromatic solvents such as toluene and xylene; glycol ethers such as tripropylene glycol n-butyl ether and tetraethylene glycol dimethyl ether; and terpenes such as pine oil and terpineol; petroleum distillate and hydroxyl terminated polybutadiene. The foregoing solvents can be used independently or in combination.

Preferably the solvent component comprises about 5 to about 95 wt % of the flux and more preferably from about 20 to about 70 wt %. If the concentration of the solvent component is less about 20 wt % of the flux composition, the viscosity of the flux is typically so high as to prevent printing and negatively impacts the coatability of the solder paste. On the other hand, if the concentration of the solvent component exceeds about 70 wt %, the flux tends to be deficient in the active fraction (e.g., the base component and the activating component) which can result in insufficient fluxing and incomplete fusion of the solder alloy during reflow.

Activating Component

The flux of the present invention comprises an activating component which comprises methylsuccinic acid. Preferably the activating component consists essentially of methylsuccinic acid. Preferably the activating component comprises about 1 to about 30 wt % of the flux and more preferably from about 2 to about 20 wt %. Methylsuccinic acid is available from numerous suppliers including SGA Specialties Group, LLC Annandale, N.J., and 5-Star Group, Lewingston, Pa.

Although considered to be unnecessary, the activating component may comprise additional compounds which typically include amine hydrohalide salts, and amine organic acid salts, phosphonic acids, phosphate esters, amino acids, alkanolamines, organic acids and combinations thereof. If present, the additional compounds preferably comprise an organic acid and more preferably comprise a carboxylic acid (e.g., mono-, di- and polycarboxylic acids) which may contain hydroxyl groups and/or double bonds. Examples of a monocarboxylic acid includes aliphatic monocarboxylic acids such as caproic acid, enanthic acid, capric acid, pelargonic acid, lauric acid, palmitic acid and stearic acid. Monocarboxylic acids also include aromatic monocarboxylic acids such a benzoic acid, salicylic acid, anisic acid, sulfanylic acid. Examples of a dicarboxylic acid includes aliphatic dicarboxylic acids such as oxalic acid, malonic acid, succinic acid, glutaric acid, maleic acid and itaconic acid and aromatic dicarboxylic acids such as phthalic acid, isophthalic acid and napthalenedicarboxylic acid. Examples of a tricarboxylic acid include tricarballylic acid, aconitic acid and citric acid. Carboxylic acids are considered acceptable because they are weakly ionic relative to halide-containing activators, such as amine hydrohalides (e.g., amine hydrochlorides and amine hydrobromides which are commonly used in the electronics industry. Moreover, being halide-free, they do not lead to the above-described corrosion of the solder metal which takes place when halides are present. If included, dicarboxylic acid compounds are preferable because they provide an acceptable combination of soldering performance, minimal residual ionic contamination, and high surface insulation resistance.

The selection of the base component and the activating component materials is based, in part, on the melting temperature of the solder alloy being used. The reaction starting temperature of the base component with the activating component is preferably lower than the melting point of the solder alloy. For example, the reflow temperature of Sn₆₃Pb₃₇ solder alloy is about 183° C. so an activating component which has a melting of about 130 to about 180° C. may be considered. An activating component with a lower melting temperature would react with the thermoplastic resin too early during the reflow operation, while an activating component with a higher melting point would not allow the solder to adequately wet resulting in an incompletely fused solder joint.

Accelerating Component

The flux of the present invention comprises an accelerating component to accelerate the reaction between the methylsuccinic acid (and any other activating components) and the base component. Stated another way, the accelerating component decreases the temperature at which the fluxing chemical reactions begin (i.e., the interaction between the activating component and the base component). The accelerating component preferably comprises an imidazole compound or derivative examples of which include 2-methyl-4-ethylimidazole, 2-methylimidazole and 2-ethylimidazole. More preferably the accelerating consists essentially of 2-ethylimidazole. Preferably, the accelerating component comprises about 0.5 to about 15 wt % of the flux and more preferably from about 3 to about 11 wt %. Imidizole compounds such as the 2-ethylimidazole are commercially available from a variety of sources including BASF.

Optionally, the accelerating component may comprise other compounds such as ammonium salts and tertiary amine. Exemplary ammonium salts include triethylbenzylammonium chloride, trimethylbenzylammonium chloride and tetramethylammonium choride. Exemplary tertiary amines include benzyldimethylamine, tributylamine and tris-(dimethylamino)methylphenol.

The relative amounts of the methylsuccinic acid and the 2-ethylimidazole are preferable selected to produce a flux composition which has excess acidity. Preferably, the weight ratio of methylsuccinic acid to 2-ethylimidazole is from about 6.7 to about 9.3 and more preferably from about 8 to about 11.

Rheological Component

To improve the printability of the solder paste the flux preferably comprises a rheological component. Typically, the rheology of the solder paste is such that it is gel-like or semi-solid when static, however, when a shear force is applied it flows like a liquid. This allows for the paste to flow through a stencil when a force is applied using a squeegee and to maintain the pattern of the stencil after the stencil is removed from the surface of the substrate. These characteristics are preferably attained by using a thixotropic agent at the rheological component. Exemplary thixotropic agents include hydrogenated castor oil, castor oil-based thixatropes such as THIXATROL ST available from Reox, Inc. and RHEOCIN available from Sud-Chemie Rheologicals, polyamides and polyethylene waxes. The rheological component may comprise one or more of the foregoing materials and the concentration of the rheological component is preferably between about 0.5 to about 15 wt % of the flux and more preferably from about 1 to about 11 wt % of the flux.

Corrosion Inhibitor Component

The flux of the invention may also contain corrosion inhibitor component to reduce or prevent corrosion of the reflowed solder joint during use and/or during subsequent heat cycling associated with the manufacturing process. Exemplary corrosion inhibitors include phosphine derivatives such as triphenylphospine and triazole derivatives such as hydroxybenzotriazole. The corrosion inhibitor component may comprise one or more of the foregoing materials and preferably comprises about 0.1 to about 5 wt % of the flux and more preferably from about 0.5 to about 3 wt % of the flux.

One embodiment of a solder flux in accordance with the present invention is set forth in the table below.

| Component | Type | Weight Percent |
|---|---|---|
| hydrogenated resin | base | 13.0-23.0 |
| | component | |
| hydrogenated gum | base | 13.0-23.0 |
| wood rosin | component | |
| glycol ether | solvent | 14.0-30.0 |
| hydroxyl terminated | solvent | 6.0-12.0 |
| polybutadiene | | |
| petroleum distillate | solvent | 3.0-15.0 |
| methylsuccinic acid | activator | 4.0-17.0 |
| 2-ethylimidazole | accelerator | 3.0-10.5 |
| thixotrope | rheological | 0.0-13.0 |
| | agent | |
| phosphine derivative | corrosion | 0.0-2.0 |
| | inhibitor | |
| triazole derivative | corrosion | 0.0-2.5 |
| | inhibitor | |

Flux Preparation

The flux composition of the present invention may be prepared by any appropriate method. Typically, the various components (i.e., the solvent, base, activating, accelerating, rheological and corrosion inhibitor components) are mixed together and heated to a sufficient temperature (e.g., between about 80° C. to about 150° C. and preferably between about 100° C. and 130° C.) and for a sufficient duration (e.g., about 60 to about 180 minutes) until a uniform and homogeneous solution is obtained.

Although not required, it is preferred that the activating component and/or the accelerating component are added to the flux composition in a manner which limits and/or eliminates chemical reactions between said components and/or the other components (especially the base components). For example, without being held to a particular theory, it is presently believed that the methylsuccinic acid and the 2-ethylimidazole react to form 2-ethylimidazole methylsuccinate which is believed to greatly enhance the flux activity. It is has been observed that the flux activity during reflow is maximized by minimizing this reaction prior to a reflow operation (e.g., during the flux preparation and during storage). Thus, at least one of the components are preferably added to the flux near the end of the flux preparation process. More preferably, both the methylsuccinic acid and the 2-ethylimidazole are added near the end of the preparation process. Specifically, as the flux preparation is being cooled to the ambient temperature, the methylsuccinic acid and the 2-ethylimidazole are preferably added after the temperature falls below about 40° C. In addition to increasing the flux activity, it has been observed that minimizing the reaction prior to reflow also benefits the stability and shelf life of the paste.

Solder Alloy

The flux of the present invention may be used with any electrical contact solder alloy such as conventional leaded solders (e.g., Sn₆₃Pb₃₇ and Sn₆₂Pb₃₆Ag₂). However, it is particularly useful to flux solder alloys that are substantially free of lead which are commonly referred to as Pb-free solder alloys and typically contain less than about 0.3 wt % of lead. Pb-free solder alloys tend to have higher liquidus temperatures and/or reflow durations than lead-containing solder alloys. Exemplary Pb-free solder alloys include: Au₈₀Sn₂₀, Sn_{96.2}Ag_{2.5}Cu_{0.8}Sb_{0.5}, Sn₆₅Ag₂₅Sb₁₀, Sn_{96.5}Ag_{3.5}, Sn_{95.5}Ag_{3.8}Cu_{0.7}, Sn_{96.5}Ag₃Cu_{0.5}, Sn_{95.5}Ag₄Cu_{0.5}, Sn_{93.6}Ag_{4.7}Cu1.7, Sn₄₂Bi₅₈, Sn₉₀Bi_{9.5}Cu_{0.5}, Sn_{99.3}Cu_{0.7}, Sn₉₉Cu₁, Sn₉₇Cu₃, Sn87.1In_{10.5}Ag₂Sb_{0.4}, Sn77.2In₂₀Ag_{2.8}, Sn_{63.6}In_{8.8}Zn_{27.6}, Sn₉₇Sb₃ and Sn₉₅Sb₅. The foregoing preferred methylsuccinic acid-containing flux composition is particularly suited for printing and fluxing Sn_{95.5}Ag₄Cu_{0.5} and Sn_{96.5}Ag₃Cu_{0.5} alloys.

When preparing a solder paste, the solder alloy is in powder form. Preferably the alloy powder particles have a size between about 100 and about 400 mesh according to Tyler Standard Screen Scale (i.e., the particles will pass through a screen having openings of about 150 μm and not pass through a screen having openings of about 38 μm). The solder powder may be prepared by any appropriate technique including inert gas atomization and centrifugal spraying.

Solder Paste

The solder paste is preferably prepared by mixing the cooled flux composition and the metal alloy powder in a conventional manner. The method of mixing is not critical but should insure that a homogeneous dispersion of metal and flux is obtained. For example, blenders and rotating blade mixers can be used. The proportions of the solder powder and the flux are selected so as to provide an admixture having a consistency suitable for printing. Generally, the weight ratio of the solder powder to the flux ranges from about 80:20 to about 95:5 and preferably from about 85:15 to about 90:10.

It is often desirable to formulate a solder paste to have a specific viscosity. Before the viscosity of the paste is tested, it is preferably allowed to stand for several hours so that a “rest” viscosity can be obtained. If necessary, the viscosity of the paste can be modified before and/or during use. For example, if viscosity is too high, additional solvent may be added or if the viscosity is too low, additional solder alloy powder may be added. Preferably, the paste is then allowed to stand again before remeasuring the viscosity.

Printing and Reflow

As described above, the solder paste is applied to selected areas on a printed circuit board by stenciling and/or screen printing. Electronic devices are mounted on the applied solder paste and the assembly is heated in a furnace to melt or reflow the solder alloy, thereby bonding the electronic devices to the circuit board. The peak surface temperature of the circuit board when heated is preferably below 250° C. and most suitably about 50° C. above the liquidus temperature of the solder alloy(s) present in the paste.

It is believed that during reflow the methylsuccinic acid and the 2-ethylimidazole react and form a salt, i.e., 2-ethylimidazole methylsuccinate, which activates the thermoplastic resin to remove oxygen from the surface of the metal solder alloy and the substrate and protects the metals being joined from atmospheric oxygen by forming a liquid that encapsulates the molten metal and prevents oxygen from reaching the solder joint during and after the reflow operation. Preferably, at least about 50% of the available methylsuccinic acid and 2-ethylimidazole react to form the activator salt. More preferably, at least about 70% of the available methylsuccinic acid and 2-ethylimidazole react to form the activator salt. After reflow, the preferred flux composition leaves a residue that is soft and allows for testing of the solder joints using circuit pin testing.

### EXAMPLES

The fluxing activity of a methylsuccinic acid-containing Pb-free solder pastes of the present invention were compared to that of Pb-free solder pastes that did not contain methylsuccinic acid using a solder ball test. The solder ball test entails placing a solder paste deposit about 6.5 mm in diameter on an alumina plate which is heated to about 225-250° C. in an oven. Alumina is not wetted by solder alloys so an adequately fluxed solder paste deposit will, upon heating, form a round and shiny ball having a diameter of about 2 mm. Poor performance of the flux results in oxidized metal powder on the surface of the alumina surrounding a larger fused ball.

Specifically, test solder pastes containing about 87-89 wt % of Sn_{95.5}Ag₄Cu_{0.5} alloy powder and about 11-13 wt % of fluxes prepared in accordance with the above flux composition table. Comparison solder pastes identical to the test paste except that it was free of methylsuccinic acid instead of phenylsuccinic acid were also prepared.

Several reflow tests were performed on test and comparison solder pastes. For example, deposits were reflowed using a constant temperature ramp of about 0.7° C./sec to a temperature of about 230° C. and then cooled (oven tolerance is +5° C.). The deposits remained above about 217° C. for about 60 seconds. The eutectic temperature of the Sn_{95.5}Ag₄Cu_{0.5} alloy is about 217° C. A few degrees (<about 5° C.) above the eutectic temperature the alloy becomes pasty and a few degrees higher the liquidus temperature is reached (i.e., the alloy is completely molten). Visible inspection of the paste deposits showed that the methylsuccinic acid-containing pastes were completely fused whereas the comparison pastes were not.

In another test, the pastes were only heated to about 229° C. which is only about 12° C. above the eutectic temperature. Even at this low temperature, the methylsuccinic acid-containing deposits formed completely fused solder balls.

For additional comparison, a typical manufacturing reflow operation for the Sn_{95.5}Ag₄Cu_{0.5} alloy entails heating the surface being soldered to a temperature between about 237° C. and about 245° C. which increases the likelihood for oxidation of the solder by the atmosphere. The commercial heating rate is about 1-2° C./s which is less harsh than the 0.5-0.7° C./s used during testing. Further, the reflow operation often includes soaks in which the printed substrate is held at a temperature during the ramp up (e.g., 60° C. and/or 180° C. for about 10-30 seconds) and the time above the liquidus temperature is from about 30-40 seconds to about 100 seconds. Increasing the duration of the reflow operation requires the flux composition be more resistant to the penetration of atmospheric oxygen through the liquid flux. Solder pastes containing methylsuccinic acid reflowed and formed completely fused joints even under such harsh oxidizing conditions.

It is to be understood that the above description is intended to be illustrative and not restrictive. Many embodiments will be apparent to those of skill in the art upon reading the above description. The scope of the invention should therefore be determined not with reference to the above description alone, but should also be determined with reference to the claims and the full scope of equivalents to which such claims are entitled.

What is claimed is:

1. A solder flux composition comprising:
a base component;
a solvent component;
an activating component comprising methylsuccinic acid; and
an accelerating component comprising an imidazole compound or derivative.

2. The solder flux composition of claim 1 wherein the accelerating component is selected from the group consisting of 2-methyl-4-ethylimidazole, 2-methylimidazole and 2-ethylimidazole and mixtures thereof.

3. The solder flux composition of claim 1 wherein the activating component consists essentially of methylsuccinic acid and the accelerating component consists essentially of 2-ethylimidazole.

4. The solder flux composition of claim 1 wherein the base component ranges from about 5 to about 95 weight percent of the solder flux composition, the solvent component ranges from about 5 to about 95 weight percent of the solder flux composition, the activating component ranges from about 1 to about 30 weight percent of the solder flux composition, and the accelerating component ranges from about 0.5 to about 15 weight percent of the solder flux composition.

5. The solder flux composition of claim 1 wherein the base component ranges from about 20 to about 50 weight percent of the solder flux composition, the solvent component ranges from about 20 to about 70 weight percent of the solder flux composition, the activating component ranges from about 2 to about 20 weight percent of the solder flux composition, and the accelerating component ranges from about 3 to about 11 weight percent of the solder flux composition.

6. The solder flux composition of claim 1 wherein the base component comprises a thermoplastic resin selected from the group consisting of wood rosin, gum rosin, tall oil rosin, disproportionated rosin, hydrogenated rosin, polymerized rosin, hydrogenated resin, hydrogenated gum wood rosin, a carboxyl-containing resin, a polyester resin, an acrylic resin, a styrenemaleic resin, an epoxy resin, a phenolic resin and mixtures thereof.

7. The solder flux composition of claim 6 wherein the base component consists essentially of hydrogenated resin and hydrogenated gum wood rosin.

8. The solder flux composition of claim 1 wherein the solvent component is selected from the group consisting of a ketone, an alcohol, an ester of an alcohol, an aromatic solvent, a glycol ether, a terpene, a petroleum distillate, a hydroxyl terminated polybutadiene and mixtures thereof.

9. The solder flux composition of claim 1 comprising a rheological component selected from the group consisting of a hydrogenated castor oil, a castor oil-based thixatrope, a polyamide, a polyethylene wax and mixtures thereof.

10. The solder flux composition of claim 9 wherein the rheological component comprises about 0.5 to about 15 wt % of the solder flux composition.

11. The solder flux composition of claim 9 wherein the rheological component comprises about 1 to about 11 wt % of the solder flux composition.

12. The solder flux composition of claim 1 comprising a corrosion inhibitor component selected from the group consisting of a phosphine derivative, a triazole derivative and mixtures thereof.

13. The solder flux composition of claim 12 wherein the corrosion inhibitor component comprises about 0.1 to about 5 wt % of the solder flux composition.

14. The solder flux composition of claim 12 wherein the corrosion inhibitor component comprises about 0.5 to about 3 wt % of the solder flux composition.

15. A solder flux composition comprising, in weight percent, a hydrogenated resin from about 13.0 to about 23.0%, a hydrogenated gum wood rosin from about 13.0 to about 23.0%, a glycol ether from about 14.0 to about 30.0%, a hydroxyl terminated polybutadiene from about 6.0 to about 12.0%, a petroleum distillate from about 3.0 to about 15.0%, methylsuccinic acid from about 4.0 to about 17.0%, 2-ethylimidazole from about 3.0 to about 10.5%, optionally, a thixatrope up to about 13%, optionally, phosphine derivative up to about 2.0% and optionally, triazole derivative up to about 2.5%.

16. A solder paste comprising a metal solder powder dispersed in a solder flux composition, the solder flux composition comprising:
a base component;
a solvent component;
an activating component comprising methylsuccinic acid;
an accelerating component comprising an imidazole compound or derivative;
optionally, a rheological component; and
optionally, a corrosion inhibitor component.

17. The solder paste of claim 16 wherein the weight ratio of the metal solder powder to the solder flux composition ranges from about 80:20 to about 95:5.

18. The solder paste of claim 16 wherein the weight ratio of the metal solder powder to the solder flux composition ranges from about 85:15 to about 90:10.

19. The solder paste of claim 16 wherein the metal solder powder is a Pb-free solder alloy powder having melting point within the range from about 70° C. to about 400° C.

20. The solder paste of claim 16 wherein the accelerator selected from the group consisting of 2-methyl-4-ethylimidazole, 2-methylimidazole and 2-ethylimidazole and mixtures thereof

21. The solder paste of claim 16 wherein the activating component consists essentially of methylsuccinic acid and the accelerating component consists essentially of 2-ethylimidazole.

22. The solder paste of claim 17 wherein the base component ranges from about 5 to about 95 weight percent of the solder flux composition, the solvent component ranges from about 5 to about 95 weight percent of the solder flux composition, the activating component ranges from about 1 to about 30 weight percent of the solder flux composition, the accelerating component ranges from about 0.5 to about 15 weight percent of the solder flux composition, the rheological component ranges from about 0.5 to about 15 weight percent of the flux weight percent of the solder flux composition, and the corrosion inhibitor component ranges from about 0.1 to about 5 weight percent of the solder flux composition.

23. The solder paste of claim 17 wherein the base component ranges from about 20 to about 50 weight percent of the solder flux composition, the solvent component ranges from about 20 to about 70 weight percent of the solder flux composition, the activating component ranges from about 2 to about 20 weight percent of the solder flux composition, the accelerating component ranges from about 3 to about 11 weight percent of the solder flux composition, the rheological component ranges from about 1 to about 11 weight percent of the solder flux composition, and the corrosion inhibitor component ranges from about 0.5 to about 3 weight percent of the solder flux composition.

24. The solder paste of claim 17 wherein the base component comprises a thermoplastic resin selected from the group consisting of wood rosin, gum rosin, tall oil rosin, disproportionated rosin, hydrogenated rosin, polymerized rosin, hydrogenated resin, hydrogenated gum wood rosin, a carboxyl-containing resin, a polyester resin, an acrylic resin, a styrenemaleic resin, an epoxy resin, a phenolic resin and mixtures thereof; the solvent component is selected from the group consisting of a ketone, an alcohol, an ester of an alcohol, an aromatic solvent, a glycol ether, a terpene, a petroleum distillate, a hydroxyl terminated polybutadiene and mixtures thereof; the rheological component is selected from the group consisting of a hydrogenated castor oil, a castor oil-based thixatrope, a polyamide, a polyethylene wax and mixtures thereof; and the corrosion inhibitor component selected from the group consisting of a phosphine derivative, a triazole derivative and mixtures thereof.

25. A process for joining two solderable surfaces, the process comprising:
applying to at least one of the solderable surfaces a deposit of a solder paste, the solder paste comprising a metal solder powder and a solder flux composition, the solder flux composition comprising a base component, a solvent component, an activating component comprising methylsuccinic acid, and an accelerating component comprising an imidazole compound or derivative;
applying heat to at least one solderable surface to reflow the solder paste thereby wetting both solderable surfaces with molten solder; and
cooling the molten solder to solidify the solder thereby joining the two solderable surfaces.

26. The process of claim 25 in which the accelerating component is selected from the group consisting of 2-methyl-4-ethylimidazole, 2-methylimidazole and 2-ethylimidazole and mixtures thereof.

27. The process of claim 25 in which the solder paste is applied by screen printing or by stenciling.

28. An electronic component assembly comprising:
(a) an electronic component having a plurality solder-wettable pads;
(b) a substrate having electrical contacts corresponding to the solder-wettable pads of the electronic component; and
(c) a solder paste between the solder-wettable pads and the electrical contacts, the solder paste comprising a metal solder powder and a solder flux composition, the solder flux composition comprising:
(i) a base component;
(ii) a solvent component;
(iii) an activating component comprising methylsuccinic acid;
(iv) an accelerating component comprising an imidazole compound or derivative;
(v) optionally, a rheological component; and
(vi) optionally, a corrosion inhibitor component.

29. The electronic component assembly of claim 28 wherein the accelerating component is selected from the group consisting of 2-methyl-4-ethylimidazole, 2-methylimidazole and 2-ethylimidazole and mixtures thereof.

30. A method of preparing a solder flux composition comprising mixing an activating component comprising methylsuccinic acid with an accelerating component comprising an imidazole compound or derivative.

31. The method of claim 30 wherein the accelerating component is selected from the group consisting of 2-methyl-4-ethylimidazole, 2-methylimidazole and 2-ethylimidazole and mixtures thereof.

32. The method of claim 31 wherein the accelerating component is 2-ethylimidazole.

33. The method of claim 32 wherein a base component, a solvent component, optionally, a rheological component, and optionally, a corrosion inhibitor component, are mixed with the activating component and the accelerating component.

34. The method of claim 33 wherein the base component ranges from about 5 to about 95 weight percent of the solder flux composition, the solvent component ranges from about 5 to about 95 weight percent of the solder flux composition, the activating component ranges from about 1 to about 30 weight percent of the solder flux composition, the accelerating component ranges from about 0.5 to about 15 weight percent of the solder flux composition, the rheological component ranges from about 0.5 to about 15 weight percent of the flux weight percent of the solder flux composition, and the corrosion inhibitor component ranges from about 0.1 to about 5 weight percent of the solder flux composition.

35. The method of claim 33 wherein the base component, the solvent component, the rheological component and the corrosion inhibitor component are mixed at a temperature ranging from about 80° C. and to about 150° C. for a duration ranging from about 1 to about 3 hours.

36. The method of claim 35 wherein the heated mixture of the base component, the solvent component, the rheological component and the corrosion inhibitor component is cooled to a temperature less than about 40° C. before being mixed with the activating component and the accelerating component.
